(19) United States
(12) Patent Application Publication
(10) Pub. No.: US 2024/0078295 A1
(43) Pub. Date: Mar. 7, 2024

(54) SYSTEMS, DEVICES AND METHODS FOR AUTHENTICATION AND AUTHORIZATION TO PROVIDE ADAPTIVE ACCESS TO RESOURCES

(71) Applicant: DOUBLE ZERO, Palo Alto, CA (US)

(72) Inventors: Remi PHILIPPE, Los Gatos, CA (US); Tim GARNER, Sunnyvale, CA (US)

(73) Assignee: DOUBLE ZERO, Palo Alto, CA (US)

(21) Appl. No.: 18/241,662

(22) Filed: Sep. 1, 2023

Related U.S. Application Data
(60) Provisional application No. 63/403,371, filed on Sep. 2, 2022.

(51) Int. Cl. G06F 21/30

(52) U.S. Cl. CPC G06F 21/30

(57) ABSTRACT

An apparatus, system, or method for authentication, authorization, and access-control is disclosed. The method includes receiving identity information from one or more sources regarding a user attempting to access a resource. The method also includes consolidating the received identity information into a contextualized identity for the user and determining whether to authenticate the user based on the contextualized identity. The method further includes receiving at least one piece of contextual information related to the user and determining whether to enforce a policy based on the authentication of the contextualized identity and at least one piece of contextual information.

### CROSS-REFERENCE TO RELATED APPLICATION

This application claims the benefit of U.S. Provisional Patent Application No. 63/403,371 filed on Sep. 2, 2022, the disclosure of which is incorporated herein by reference in its entirety.

### BACKGROUND

The present disclosure generally relates to an adaptive access system to provide a secure exchange, authentication, authorization, and connectivity between services.

A continuous advance in cyber threat sophistication, coupled with constant news of the latest cyber breaches and attacks, has made Information Security (InfoSec) top priority or concern for companies. Solution categories including Cross-Layer Detection and Response (XDR), micro-segmentation (uSeg), Identity and Access Management (IAM), Zero Trust Network Access (ZTNA), Privileged Access Management (PAM), and Secure Access Secure Edge (SASE), have emerged to address the InfoSec landscape. These technologies often lead to a further fragmentation of the overall security architecture.

Traditional security architectures like perimeter security are being stretched to the point of breaking. On one side, applications are now distributed across cloud infrastructure, SaaS, and on premises resources, rather than being centralized in a small number of data centers. On the other side, hybrid work forces also pull those same security tools. Users frequently move between office, home-office, and remote work. This in combination with connected devices and things further stretches existing security architectures. This distribution of resources on both sides of the traditional perimeter moves application traffic from corporate networks and Virtual Private Networks (VPN) onto the internet. This expands the attack surface amplifying existing vulnerabilities while further complicating security operations. Distributing resources across public networks negates the use of network-based security and identity tools, as well as reliance on network mappings to assign trust. This creates a requirement for new authentication and authorization tools. With these new tools come new identity silos, increasing operational overhead, while adding to the complexity and risk.

Distributed access has led to the wide adoption of encrypted transport using Transport Layer Security (TLS). TLS provides encrypted communication at the application layer, providing high interoperability and ease of deployment. For example, TLS would provide an encrypted connection over the internet between a user in a home office and an application running in a SaaS cloud. However, TLS lacks an authentication mechanism for the actor, as well as a mechanism for granular authorization.

This distribution also leads to a fragmentation of identity tools. On-premises tools like Lightweight Directory Access Protocol (LDAP), Active Directory (AD), Radius, and Terminal Access Controller Access Control System (TACACS) do not support cloud resources. As cloud adoption expands, new identity silos are implemented in the form of provider Identity and Access Management (IAM) and web-based Single Sign-On (SSO). These fragmented silos create administrative overhead, operational costs, reduced agility, and increased complexity. For example, multiple identity sources must be maintained, coordinated, audited, etc. This complexity increases the risk of error and vulnerability. It also leads to user friction, degrading the overall user experience. This reduces productivity while increasing the potential for user implemented security and identity workarounds like password reuse as user friction often leads to security circumvention (e.g., a user unable to remember regularly changing complex passwords simply wrote them down on a sticky note attached to their computer monitor). These types of solutions are also missing context. For example, in IAM solutions, a user is authenticated, and therefore granted all permissions associated with that user, regardless of other relevant factors.

In addition, this distribution also creates challenges with verification and authorization granularity. Traditional identity systems focused on verifying the user. These have evolved from username and password to multi-factor authentication (MFA) solutions and are designed to verify the user before granting access. Modern verification and authorization require much deeper levels of authentication granularity, which often come at a cost of degraded user experience.

### BRIEF SUMMARY

The present disclosure is directed to systems, apparatus, methods, and computer program products for an adaptive access platform that provides authentication, authorization and connectivity between services that does not require use of a VPN. In embodiments of the present disclosure, the adaptive access platform may include an agent and identity tokens. In embodiments of the present disclosure, the adaptive access platform may consider visibility to understand which one or combination of user, device, or process is initiating connection(s) and to which service. Visibility may include the context of a device or actor, such as security clearance for the actor or other suitable contextual information regarding the actor. Context may also be tied to physical hardware constructs, such as the Trusted Platform Module, CPU ID, or other suitable hardware identifier. For example, the context may be capturing Bluetooth neighborhood to infer precise location or environment, e.g., a public space with lots of devices for example or a private space with few devices. Visibility may also include Wi-Fi positioning, such as specific location information (i.e., inside a building and/or in which room) or a more general location (i.e., which street). The adaptive access platform may provide authentication functionality, including a context rich authentication solution based on an identity. For example, an agent according to embodiments of the present invention may also provide multi-factor authentication (MFA) capabilities. In this example, a customer may connect the agent to Azure/Okta as an MFA device, similar to an authenticator application on a smart phone or laptop. The adaptive access platform may then leverage the context of the identity to decide if agent needs to interact with a user in order to decrease user friction. The adaptive access platform, on both client and server side, may provide authorization functionality and allow a connection based on a set of claims. The adaptive access platform may transparently direct traffic through a tunnel by connecting to the closest service if multiple services are available.

### BRIEF DESCRIPTION OF THE DRAWINGS

FIG. 1 is block diagram of an example of a traditional prior art security solution.

FIG. 2 is a block diagram of aspects of an adaptive access platform according to an embodiment of the present invention.

FIG. 3 is a block diagram of an adaptive access platform according to an embodiment of the present invention.

FIG. 4 is a block diagram of aspects of an adaptive access platform according to an embodiment of the present invention.

FIG. 5 is a flow chart of an adaptive access platform according to an embodiment of the present invention.

FIGS. 6A & 6B are flow charts of an adaptive access method according to an embodiment of the present invention.

In the aforementioned figures, like reference numerals refer to like parts, components, structures, and/or processes.

### DETAILED DESCRIPTION OF THE INVENTION

As will be understood by those of ordinary skill in the art, aspects of the present disclosure may be illustrated and described herein in any of a number of patentable classes or contexts, including any new and useful process, machine, system, device, platform, manufacture, or composition of matter, or any new and useful improvement thereof. Accordingly, aspects of the present disclosure may be implemented entirely as hardware, entirely as software (including firmware, resident software, micro-code, etc.), or by combining software and hardware implementations that may all generally be referred to herein as a “module,” “component” “platform,” or “system.” Furthermore, aspects of the present disclosure may take the form of a computer program product embodied in one or more computer-readable media having computer-readable program code embodied thereon.

Any combination of one or more computer-readable media may be utilized. The computer-readable media may be a computer-readable signal medium or a computer-readable storage medium. A computer-readable storage medium may be, for example, but not limited to, an electronic, magnetic, optical, electromagnetic, or semiconductor system, apparatus, or device, or any suitable combination of the foregoing. More specific examples (a non-exhaustive list) of the computer-readable storage medium would include the following: a portable computer diskette, a hard disk, a random-access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Computer program code for carrying out operations for aspects of the present disclosure may be written in any combination of one or more programming languages, such as any of the programming languages listed at https://githut.info/ (e.g., JAVASCRIPT, JAVA, PYTHON, CSS, PHP, RUBY, C++, C, SHELL, C #, OBJECTIVE C, GOLANG, RUST, etc.) or other programming languages. The program code may be executed by a processor or programmed into a programmable logic device. The program code may be executed as a stand-alone software package. The program code may be executed entirely on an embedded computing device or partly on an embedded computing device (e.g., partly on a server and partly on a personal computer and partly on an embedded device). The program code may be executed on a client, on a server, partly on a client and partly on a server, or entirely on a server or other remote computing device. The program code also may be executed on a plurality of a combination of any of the foregoing, including a cluster of personal computers or servers. The server or remote computing device may be connected to the client (e.g., a user's computer) through any type of network, including a local area network (LAN), a wide area network (WAN), or a cellular network. The connection also may be made to an external computer or server (e.g., through the Internet using an Internet Service Provider) in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. Those computer program instructions may be provided to a processor of a general-purpose computer, special purpose computer, or other programmable data processing apparatus to produce a machine, such that the instructions, which are executed via the one or more processors of the computer or other programmable instruction execution apparatus, create a mechanism for implementing the functions/acts specified in the flowchart and/or block diagram block or blocks.

Those computer program instructions may also be stored in a computer-readable medium that, when executed, can direct a computer, other programmable data processing apparatus, or other devices to function in a particular manner, such that the instructions, when stored in the computer-readable medium, produce an article of manufacture that includes instructions which, when executed, cause a computer to implement the function/act specified in the flowchart and/or block diagram block or blocks. The computer program instructions also may be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

For a more complete understanding of the nature and advantages of embodiments of the present invention, reference should be made to the ensuing detailed description and accompanying drawings. Other aspects, objects and advantages of the invention will be apparent from the drawings and detailed description that follows. However, the scope of the invention will be fully apparent from the recitations of the claims.

To drive granular security zones, to remove default trust, and to connect users to distributed resources securely around the globe, there is a requirement to authenticate both ends of a transaction and implicitly authorize it. There is a need to develop a solution to deliver this secure exchange, authentication, and authorization at scale, integrated with existing systems, across a distributed IT environment. There is also a need to allow organizations to develop their own access and authorization policies and determine how to enforce those policies on a granular level. There is a need to provide a way to layer trust on role management in a way to mitigate the risk and help the user understand security risks, if any.

With remote and hybrid work growing exponentially, a number of identity exchanges will occur increasingly across public networks and originate from public Wi-Fi or other connections. Users are more frequently accessing corporate resources from public locations, such as coffee shops, that would have traditionally been access only on-site. In particular, this problem is illustrated by the popularity of what are referred to as “digital nomads,” who depending on the industry they are working in and the country they are located in, could create a conflict for their employer. This work from public locations or off-site in turn may leave users vulnerable to threats, such as Man-in-the-Middle (MitM) attacks or identity token theft, as well as more “low tech” attacks like eavesdropping from other people and other devices “listening” (e.g., Alexa or Google Home). These types of eavesdropping or “listening” may be detected using embodiments of the present invention, such as based on the Bluetooth and/or WiFi context information from the agent described herein. This increase in working and accessing corporate resources from public networks may also raise more general privacy concerns such as application fingerprinting unencrypted traffic for reconnaissance or advertisement purposes. Accordingly, the disclosed embodiments of an adaptive access platform may improve and protect identity verification while decreasing user friction, particularly in this remote and hybrid work environment, including through enhancements to identity exchange security, identity correlation, contextual authorization, and integration of authentication and authorization. As used herein, platform may include a system, device, and/or apparatus, including software, hardware, or a combination of software/hardware.

For example, many identity systems focus on verification from the user side (e.g., having user enter a password). However, verifying both sides of the authentication process, or mutual verification, is critical to modern security architectures. It is important to protect resources like applications, servers, and workloads from unauthorized use. However, it is also important to protect the user-end as allowing users to authenticate to compromised devices also creates a potential to propagate the vulnerability and obtain critical identity components for malicious use elsewhere.

This also applies for multi-factor authentication (MFA). MFA has basic contextual information, but it is important to include additional context and require user input only when deemed necessary (e.g., as defined by the customer) in order to increase security while decreasing user friction.

According to embodiments of the present disclosure, a uniform identify plane may be provided that is based on a contextualized, verified identity. With secure identity transport, the present disclosure may allow authorization to occur as close to the resource as possible. This may require that a verified identity, or token representation of the verified identity (i.e., identity token), be available at the authorization point. A transportation mechanism may be required to ensure identity is always on and available. Such a transportation mechanism may be secured to prevent the risk of token or credential hijacking of a verified identity. Securing identity transport according to the present disclosure may provide additional benefits, such as privacy and standards unification. Encrypting identity transport protects the identity information of the user or device across the network. Creating the secure transport layer for identity may also provide a platform to standardize and upgrade protocols. For example, this may include standardizing the latest version of TLS or removing legacy TLS and SSL usage.

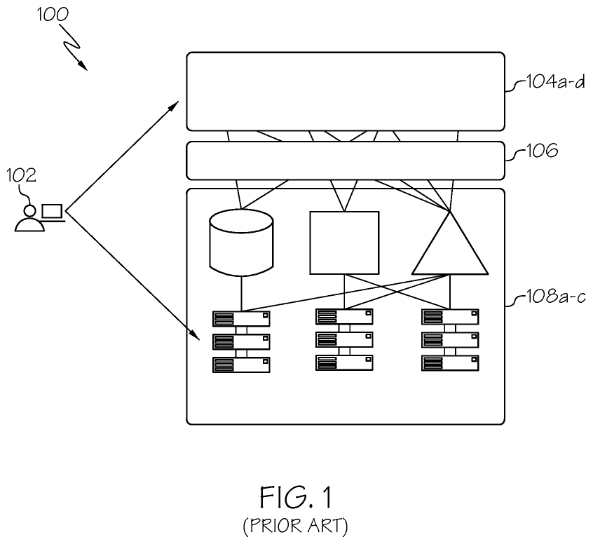

As illustrated in FIG. 1, a user 102 accessing resources with traditional identity access 100 may be widely fragmented across on-premises or private infrastructure resources 108 (e.g., databases 108a, directories 108b, active directory 108c) and cloud resources 104 (e.g., Amazon web services account 104a, Microsoft Azure 104b, Oracle 104c, Google Cloud 104d) with perimeter security systems 106 between cloud resources 104 and private or on-premises resources 108. Systems like Active Directory may exist on-premises or in the cloud (e.g., Azure AD) for managing identity for legacy resources while separate IAM and SSO tools manage Infrastructure-as-a-Service (IaaS), Software-as-a-Service (SaaS) and other platforms. These separate tools for each resource may be referred to as “silos.” Such identity and authorization silos create issues with identity consistency, access, and duplication. Without a single Source-of-Truth (SoT), multiple systems must be kept updated and must be queried when requesting information. This expands the attack surface of identity resources, while exponentially increasing complexity, which in turn amplifies the risk of error, etc.

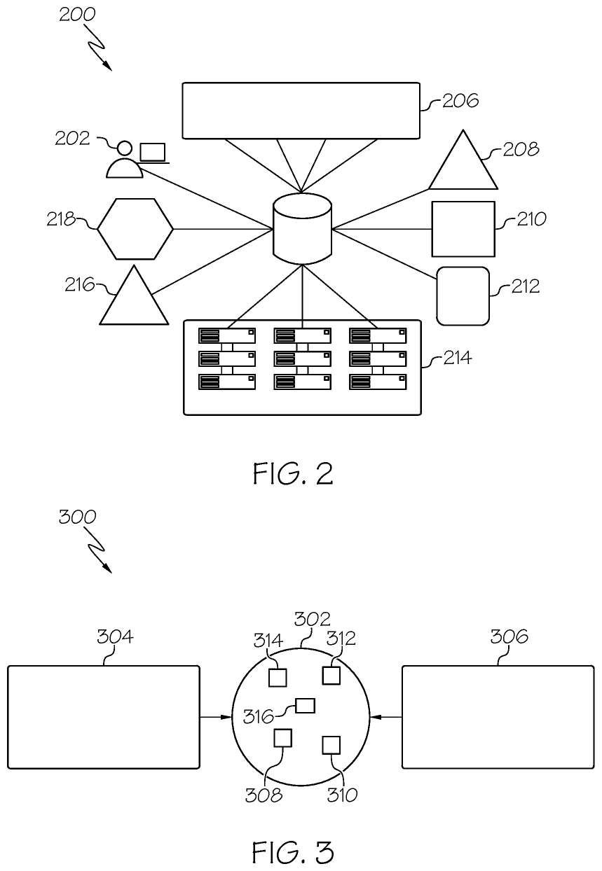

As illustrated in FIG. 2, embodiments of an adaptive access system 200 according to the present disclosure may use an abstraction plane (uniform identity plane or “trust plane”) for identity transactions involving user 202. In certain example embodiments of the present invention, the abstraction plane may become a central, virtual, or consolidated identity repository 204. Consolidated identity repository 204 may be configured to receive and accept outside identity sources and consolidate them into a single “source of truth” or uniform identity or consolidated identity or single universal identity for user 202. Adaptive access system 200 may receive a “shadow” identity from an outside source, such as Okta, Azure, or Office 365, that is referenced in consolidated identity repository 204 rather than copied from the outside source. Consolidated identity may be used for identity verification across a hybrid or multi-cloud environment. In the example embodiment of FIG. 2, consolidated identity repository 204 may accept identity information from one or more of the following sources: public cloud applications 206 (e.g., Amazon web services, Microsoft Azure, Oracle, Google Cloud, or other cloud application or service), enterprise/private active directory 208, enterprise/private directories 210, enterprise/private databases 212, private infrastructure or other enterprise applications 214, external identity source 216, and/or external SSO 218, or any other suitable source of identity information.

This identity abstraction according to embodiments of the present invention may provide both backward and forward compatibility, which may create an open extensible platform. The abstraction plane receives available identity information from existing sources and correlates it into a single universal identity. The contextualized, single universal identity may then be used for authentication and authorization. Consolidated repository 204 may be the source of foundational data from which to build a contextualized identity of user 202. An individual user 202 may have several different “identities” from the perspective of enforcement, auditing, and logging tools across an enterprise. Connecting or otherwise relating these several different “identities” together in a contextualized identity according to embodiments of the present disclosure may unify security enforcement of authorization, monitoring, reporting, and forensics of user actions across an enterprise.

In an example according to aspects of the present disclosure, a work-from-home (WFH) social media manager may have three different “identities.” For example, the social media manager may use a corporate identity tied to Active Directory (AD) to log in to their laptop, work email, and other suitable applications, resources, or services. The social media manager may also be responsible for posting video content to YouTube using a Google login (or other suitable social media, content sharing, or other resource) (“admin identity”). Using that same Google login, the social media manager may collaborate with others on video scripts and storyboards by using Google Docs. In addition, the social media manager may also maintain a separate work-focused Google account to use when viewing the YouTube Channel as a non-administrator/standard viewer (“view identity”). In this example, the single user (social media manager) has three different “identities:” (1) Active Directory identity, (2) Google YouTube Admin identity, and (3) Google YouTube Viewer identity. This could be any number of different “identities” depending on the accounts formed by a user, or the services/resources that the user needs to access and the context in which the user accesses those services/resources.

Embodiments according to the present disclosure may enable correlating these separate identities to create a contextualized view of the user. According to embodiments of the present disclosure, these would not be viewed as three separate identities, but rather as three functions or roles of one user that may be correlated for enforcement, logging, auditing, or other purposes. Through this correlated contextualized identity, embodiments according to aspects of the present invention may account for machines, devices, and things. An example of using such hardware context includes supply chain attacks. This may be particularly useful as the adoption of 5G cellular networks, and the proliferation of Internet of Things (IoT) devices are growing rapidly and changing where and how users access resources. Coupled with these devices are the software, services, and processes that require identity-based authorization for access to external systems and software. These non-human identities must be accounted for and correlated where required. This precise machine identity is even more critical for hard-to-patch IoT devices which may require separate authorization standards when patch levels fall behind defined thresholds.

While application specific identity data may be retained within existing systems, in order to provide a contextualized view of the user, service, or device, and auditing of all authentications to enterprise systems, the specific, separate identity data must be correlated across various identity and enforcement systems. Creating (or correlating or consolidating) a single contextualized identity according to embodiments of the present disclosure provides a platform from which every identity decision can be made accurately at scale, while maintaining transactional records.

Embodiments of the present disclosure may also account for contextual authorization. Context may include time, location, connected network, employment status, or any other relevant factor. In some embodiments, contextual information may be made available along with identify to be used in granular authorization. In an example embodiment, a company has a new hire software developer. During the first weeks of their employment, the new hire software developer may be on a probationary period with limited access to specific systems and actions, such as production code updates. As the software developer grows in seniority, these limitations to their access may be lifted such that they have access to all systems and actions. If the software developer submits a resignation with notice those limitations on their access may expand significantly to limit their access during the notice period. In another example of using context according to aspects of the present disclosure, a policy may be set, or an enforcement decision may be made to deny access to sensitive data when in-flight Wi-Fi is detected because of the physical constraints of air travel, and the known risk of seatmate onlookers.

Embodiments of the present disclosure provide the capability to exchange identity information between the application (Layer 7) and the network (Layer 3). Networks may provide context like location and network-based identity such as Remote Authentication Dial-In User Service (RADIUS). In return, a uniform identity plane according to embodiments of the present disclosure may provide authentication and authorization information back to the network. According to an example embodiment, passing this information in packet headers may make it available to all network devices even when the flow is encrypted.

An adaptive access system 300 according to an example embodiment of the present invention is depicted in FIG. 3. Adaptive access system 300 may deliver consistent, high-definition, context rich identity securely between accessor identity 304 (i.e., the user or entity trying to access a resource or service) and resource identity 306 (i.e., the resource or service being accessed) via platform 302. Accessor identity 304 may be one or more of user, device, device posture, network, and any other suitable accessor identifier or combination of these factors. Resource identity 306 may be machine ID, process hash or other suitable resource identifier. Platform 302 provides a foundation for “zero trust” by globally correlating identity with enforcement through a policy engine 308. This may allow for granular least-privilege access without exponential overhead to security operations. Platform 302 may also be referred to as a uniform identity plane. Platform 302 may also include token lake 310, token 312, service locator 314, and agent 316. Token lake 310 may store or serve as a repository of a collection of tokens 312. Token lake 310 may enable the stored tokens 312 to be searchable or browsable or otherwise able to accurately the trace the history of a particular token 312. The platform 302 may operate as an independent identity plane, providing a source of unified identity, such as consolidated identity repository 204. That unified identity may be formed by consolidating information from one or more components or combination of components, such as the user/actor, the device, and the process. This identity information or data may be ingested from existing sources, correlated (or consolidated or otherwise unified), then securely transported to the resource where a policy decision and authorization can be made. This may be followed by an enforcement decision made depending on the policy decision and authorization.

Adaptive access platform 302 according to an embodiment of the present disclosure may provide optional enforcement and/or the ability to hand off policy enforcement to the tool(s) of choice for the user, enterprise, or other operator of the device or resource. Optional enforcement may be incorporated into platform 302 to provide authorization granularity and consistency. This may be used to augment existing enforcement points or consolidate existing tools. Visibility and auditability are also enhanced because with platform 302 each authorization action is correlated with the identity, context, and policy that resulted in a decision to permit, deny, or take other suitable action for the request. Policy enforcement options, such as to take other suitable action, include but are not limited to network-based blocking, host-based blocking, limiting visibility, rate limiting, forced data locality, and geo load-balancing, simulate a network failure, or other suitable enforcement options depending on the requirements of the enterprise. Enforcement may also include providing an alert or notification to a user without preventing access to the resource. For example, a user attempting to access sensitive information on airplane WiFi may receive an alert or other notification that the environment may not be secure and may also ask the user to confirm they wish to continue with accessing the resource. Enforcement actions may also include denying access or otherwise throttling access to the resource or service. The types of enforcement actions may be dictated by policy that is integrated with or otherwise communicates with platform 302.

Embodiments of the present invention may allow for additional granularity (as required or desired) in granting access using context. Once a user is authenticated, instead of granting all permissions associated with that user as a default regardless of (or without considering) any other relevant factors, embodiments of the present invention may use context of other relevant factors to provide more granularity. Examples of other relevant factors include but are not limited to time, location, and employment status. Additional examples of relevant factors include whether the user is on a trusted device, whether the device has an acceptable security posture, whether the user is performing administrative tasks, whether the user is on a secure or otherwise trusted connection, whether the connection is encrypted, identification of other existing connections of the user, whether the user is engaging in abnormal access behavior, whether the requested action is authorized in this context, whether there is context information related to identity verification, whether there are policies that can ensure use access is limited to permissions based on context, whether the user in a restricted location (e.g., public space or country), or any other suitable factor providing information on the user's context which may impact security.

Platform 302 may combine identity verification, policy application, and authentication enforcement into an open and extensible platform. As described herein, providing adaptive access according to embodiments of the present disclosure may begin with a dynamic universal identity correlated (or consolidated) from private (on-premises) and public (off-premises/cloud) identity sources, for example, AD on premises and Okta for SaaS applications. By integrating with existing sources of identity information, platform 302 may provide a consistent granular identity with enhanced global auditability (contextualized identity).

Platform 302 may act as an integrated (or uniform) identity plane. To achieve this, platform 302 may integrate with and accept identity (or identity information/data) from existing external sources, including but not limited to Okta, Azure AD, Office 365, Active Director, and LDAP. This integration is foundational to building a contextualized identity view. According to embodiments of the present invention, integrations may be accomplished non-disruptively using read-only API access. In platform 302, identities from any given source may be correlated together into a master (uniform) identity view. By receiving information, data, and identities from various sources, and then correlating that received information, platform 302 may provide global visibility of any given identity, the devices that identity uses, and the resources that identity accesses. This may instantly provide an enhanced level of visibility for identity actors, such as being able to show all the resources a user accessed last week.

Identity sources provide one component of an identity decision by platform 302 according to embodiments of the present disclosure. Authorization decisions may also consider other factors, such as the device in use, and the process initiating the action. Essentially, platform 302 determines whether this user/device/process allowed to access this service with its current context. By considering the combination of actor and service, platform 302 may account for more granular circumstances, such as where an action may be authorized on company issued devices, but not on personal devices, or on company Internet, but not on public WiFi. Alternatively, access to a system or dataset may only be authorized for a specific process. Platform 302 may also integrate with the platforms and protocols to provide additional identity constructs and various contextual information, including but not limited to Microsoft Intune (Mobile Device Management (MDM)), Kandji (MDM), Jamf (MDM), Salesforce (Authorized record access), GitHub (Authorized repot access), DropBox (Authorized file access), Box (Authorized file access), Office 365 (Authorized resource access), NetFlow (Network data), and Syslog (Network data).

The identity may be further enhanced through device and process information, along with contextual metadata. Platform 302 may use various types of contextual information to provide for granular policy authoring and enforcement. For example, a user's trust level could be adjusted automatically as they travel based on location and network security, geo-location related compliance regulations, and other relevant contextual information. In the example of traveling, a user may have limited access while in-flight even with an encrypted connection due to the risk of exposure to nearby onlooking passengers. Additional context examples include human resource status where platform 302 may enforce policies based on employment status (e.g., new hire, regular employee, contractor, within resignation/notice period), attached network where platform 302 may enforce policies based on the assigned trust of various networks (e.g., corporate network is assigned high trust, home office is assigned medium trust, and public network is assigned low trust), and location where platform 302 may enforce geo-location based policies (European Union versus US) and location security based (is the device, displayed information, etc. secure from theft/prying eyes in this location (e.g., on a train, bus, or plane), is the user on business or personal travel, etc.).

As described herein, platform 302 may receive identity information/data and correlate that data into a globally correlated identity, which may also be referred to as a contextualized identity. For example, platform 302 may combine Azure AD, local AD, and Okta identity sources into a single identity view. The single identify view may include contextual information such as location, device, connected network, and other suitable context depending on the enterprise needs. This may provide a strong dynamic identity for policy authoring and enforcement, while eliminating issues caused by identity fragmentation.

Within platform 302, this single unified, contextualized identity may be represented as identity token 312. Identity token 312 may be securely transported to a point of authorization (POA) as close to the resource as possible. There may be any suitable number of identity tokens (e.g., actor, device, process, context) or token 312 may represented a contextualized view of device, process, actor, and context, i.e., a contextualized identity. In some embodiments of platform 302, native enforcement actions may optionally be applied at this same point of authorization. Platform 302 manages the full lifecycle of authentication, transport, and authorization providing a unified tool for visibility, policy, and enforcement. Identity tokens 312 according to the present disclosure may be comprised of a hashed certificate based on a suitable protocol, software, or standard, such as Secure Production Identity Framework for Everyone (SPIFFE). Token 312 may be a specially crafted X.509 certificate, which encodes a data in a stateless fashion for use across a network. Token 312 may be compatible with a variety of existing systems. According to additional aspects of the present disclosure, a proxy may be provided for older tokens to further enhance compatibility with systems.

Tokens 312 according to the present disclosure may be non-persistent and controlled by a dynamic time-out. Tokens may expire after dynamically specified, configurable, periods. This allows policy to dictate the time-out periods for various actions or contexts. Higher risk situations can utilize shorter lived tokens. For example, a user at a home office may have a long-lived token to decrease friction. That same user may have a short-lived token at the airport to enhance security. Handling this automatically on the backend via identity and context means that the only friction the user experiences is limitations based on defined policy.

Tokens 312 may also be revokable. As a contextualized identity plane, platform 302 allows revocation of the global authorization for a user or device from a single control point. An example would be revocation upon termination of an employee for cause. Another example would be revoking access for a specific device type, or system globally in the event those devices had a known compromise.

Securing the identity tokens 312 themselves is a critical component of adaptive access system 300. Ensuring that identity tokens 312 and context are transported across encrypted tunnels may prevent token hijacking, MiTM attacks, and other similar exploits. Encrypted tunnels may also ensure the integrity and security of the identity information itself. In an example embodiment of the present disclosure, platform 302 may utilize the QUIC protocol to initiate these tunnels. The QUIC protocol operates in a stateless fashion without the complexities, limitations, and friction of VPN access. The stateless nature makes this protocol ideal for environments like air travel where limited bandwidth, high-latency, and intermittent connectivity can lead to issues with technologies like VPN. For example, VPN capabilities rely on a service catalog, where server agents register the services running on server or server agent(s) and the administrator can decide which services to expose and which policies apply to them. The VPN-less sessions are stateless and should connect to the closest service if multiple services are available.

Agent 316 may provide authentication, authorization and VPN-less connectivity between services and may allow for secure, granular access on a process level. As a result, embodiments of the present invention may improve visibility to understand which processes are initiating connections to which external service and which may facilitate policy development. Visibility also includes the context of a device or actor. For example, capturing Bluetooth neighborhood to infer precise location or environment (e.g., public space with lots of devices). Visibility may also include WiFi positioning (e.g., Core Location for Apple platforms). Authentication provides a context rich authentication solution based on user, device, and process. According to embodiments of the present disclosure, user, device, and process (“triplet”) form the identity. In some embodiments of the disclosure, a machine can hold multiple identities (e.g., a service account running a process). Authorization may be based on a catalog of services and context, and a user may have access to a subset of those services.

Agent 316 is software or code and may be downloaded or installed on a client/user device, sever-side, or both. According to embodiments of the present invention, agent 316 may operate without a VPN. Secure agent may transparently direct traffic through a tunnel (e.g., QUIC) should the user have access to it. The VPN capabilities may rely on a service catalog, where secure agents on the server register the services running on server or server agent(s) and the administrator can decide which services to expose and which policies apply to them. Service catalog may also apply geo constraints, such as a user is based in the US and cannot access a server based in Europe due to a GDPR risk. The VPN-less session may be stateless and may connect to the closest service if multiple services are available.

Each agent 316 may run a suitable instance on it, such as SPIRE (the SPIFFE Runtime Environment). In order to attest other processes, agent 316 provides a workload API for any application that wants to leverage it. Both client and server provide a set of base capabilities. The server allows incoming connections, whereas client does not. However, a server can also act as a client to access remote services. Agent 316 may also act as a “companion” to authentication. For example, an agent 316 running on a phone can tell an agent 316 running on a laptop that it's nearby. This allows to verify that the user is in reality the user. For example, if agent 316 determines the phone is 1000 miles from the user, agent 316 may determine the user is not in fact the user because the odds that the user is that far from the user's phone are low. The companion can be a phone, a watch, a hardware beacon, or any other suitable device. This type of determination may also be used in multi-factor authentication scenarios.

Agent 316 may implement plugins in order to support utilization of SPIFFE (https://spiffe.io), including through a node resolver (e.g., TPM, MDM), a Key Manager, or a workload attestor. An example implementation of agent 316 using SPIRE may also support the other operating systems (e.g., Mac, Windows, Linux) that may interface with agent 316, including a C implementation and a Rust implementation.

In an example embodiment, agent 316 may have a stream connection from a server to agent 316. This connection may handle notification, push updates, data channel receivers, and other suitable communication. For unary operations, agent 316 may call individual graph endpoints. In addition, a data channel may be used for visibility that provides a one direction stream to platform 302/agent 316. A data channel may support buffering with a configurable interval, such as using SQLite. Data may also be collected as time series and if so agent 316 may maintain this as much as possible. Data may also be aware of low bandwidth connections (airplane, tethering, etc.) and adjust as needed. Control channels may run over the GraphQL subscription. An example of server-side implementation may be with gqlgen. An example embodiment of the data channel may be a direct gRPC connection. Agent 316 may also be designed to work collaboratively with a user of the system and as such, control channel may also be used for notifications or interactions.

According to embodiments of the present invention, there may be a minimal set of control channel commands. These may include commands from agent 316 to control such as create, delete, publish, provide a list of other agents 316, and any other suitable commands. These may also include commands from control to agent 316, such as upgrade, notification, policy, and any other suitable commands. There may also be a minimal set of data messages and each message payload may include process information, including for file and network. However, with short-lived processes the processes may not be captured during a scan interval. According to embodiments of the present invention, the flow may be combined with the process data such that even short-lived processes may also be captured. In one example, process data may include process tree for the specific process.

Agent 316 may provide remote access through a tunnel. According to an embodiment of the present disclosure, the encapsulation protocol may be QUIC with MASQUE or other suitable encapsulation protocol.

Agent 316 may authenticate. According to embodiments of the present disclosure, agent 316 may provide a context rich authentication solution based on one or more factors, including user, device, and process. As described herein, in an embodiment, user, device, and process may be correlated or unified to form the contextualized identity (“triplet”). A machine may hold multiple identities (service account running a process, for example). In one embodiment, authentication may flow from the user/agent 316 back to platform 302. Such authentication may rely on a classical SSO flow. Agent 316 may open a browser window that may redirect to platform 302. Two factor authentication or another authentication mechanism may be handled through the browser window. Platform 302 may serve as an identity provider and may have all the federation to users of platform 302. Platform 302's IDP may be used for both users of the full platform 302 and end users that have an agent 316. Based on the catalog of services and context, a user may have access to a subset of services. Agent 316 (both client and/or server side) may allow a connection based on a set of claims. Agent 316 may also provide multi-factor authentication (MFA) capabilities. In this example, a customer may connect agent 316 to Azure/Okta or other suitable authenticator application on a smart phone, laptop, or other device, as an MFA device. Adaptive access platform 300 may then leverage the context of the identity to decide if agent 316 needs to interact with a user in order to decrease user friction. Types of interaction with the user include, request an approval on a phone, require infosec validation, detect the presence of the user's phone within a certain distance via Bluetooth, and/or other suitable requests. Adaptive access platform 300 may also integrate with FIDO2 or other suitable web-based authenticators through agent 316 as an MFA device.

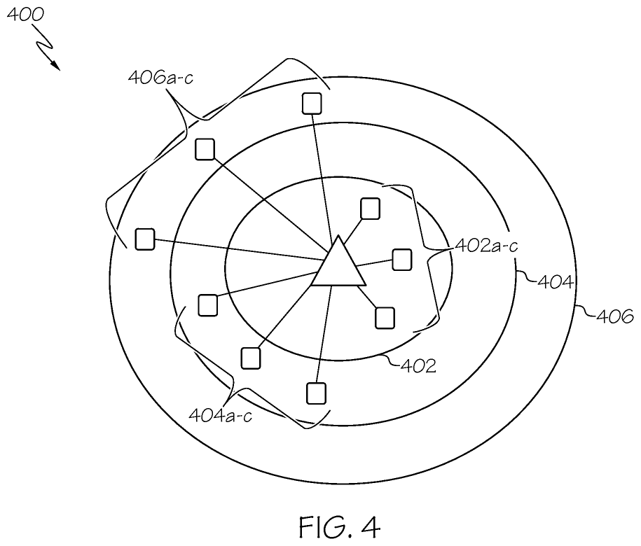

In an example embodiment depicted in FIG. 4, a contextualized identity 400 for user 408 may be formed using information about the resource 402 being used or accessed, device 404, and context 406. FIG. 4 depicts forming an identity by correlating information from resources 402a-c, devices 404a-c, and contexts 406a-c. This is an example and could be any suitable number of resources, devices, and contexts. For example, resources 402a-c may include applications, websites, or services such as Dropbox, Gmail, Amazon, WebEx, Office 365, devices 404a-c may include a smartphone, a tablet, or a laptop, and contexts may include location (e.g., airport, in-flight, hotel, coffee shop, office), employment status, network trust level, behavior baseline.

Certain functions of embodiments of the present invention may not be supported across different operating systems. In one example embodiment, one or more functions may be stored as a core component(s) in one or more multi-platform or core libraries such that the function does not have to be recoded for every implementation. Such core libraries may be built in Rust and be as platform agnostic as possible. Examples of libraries include, authentication and authorization (SPIFFE), service catalog, control plane (GraphQL), data channel (Protobuf), encapsulation protocol.

### Policy

Referring back to FIG. 3, in another aspect of embodiments according to the present disclosure, platform 302 may enable policy authoring to be more robust and granular than a simple permit or deny. Traveling and hybrid-work employees have presented new and unique challenges to security. As the employee's environment changes, the devices they use, networks they connect from, and physical security posture also change. These changes may often translate to policy differences. Leaving the European Union (EU) on business travel might require restricting access to Personally Identifiable Information (PII) protected by General Data Protection Regulation (GDPR). When in-flight, policy may dictate that access to proprietary intellectual property (IP) be restricted due to the close quarters and risk of onlookers. Required policies authored using policy engine 308 of platform 302 may throttle data access, place limits on access resources, or place other suitable limits on access. This may lead to enhancing security and reducing security generated user friction. With granular policy, user productivity may be maximized while organizations can lock down data and resources as needed.

According to an embodiment of the present disclosure, policy engine 308 may use Open Policy Agent (OPA) for policy authoring. OPA relies on the Rego policy language, combined with JSON unstructured data, to decouple policy definition from implementation. This may provide a unified method for authoring policy and a framework for policy distribution. OPA utilizes a declarative policy model, which allows high level policy language to be distributed to a broad variety of enforcement points, where it can be implemented utilizing more granular platform specifics. OPA is a broadly adopted open platform and, as such, may provide many advantages in the form of policy reuse, knowledge availability, and policy ecosystem. Policy from other systems relying on OPA can be utilized within platform 302, while other policies can be adopted from the community and modified as needed. As a widely adopted platform knowledge of OPA and its administration is widespread, and a large online ecosystem of knowledge, resources already exist. In addition, OPA is context aware. This may allow the policy to utilize external information sources to provide background for policy decisions. Contextual awareness extends the capabilities of the platform and alleviates the need for overly complex roles. This provides a robust platform for policy language that adapts seamlessly to the environment.

Policy or policies may then be enforced against the identity, which may match the user and device to contextual information like network, geo-location, and HR status. This allows for the utmost configurability and adaptability without adding additional complexity or user friction. Policies authored using policy engine 308 of platform 302 may adapt with the user as the context changes. According to an example embodiment of the present invention, context changes could be a user moving from corporate Wi-Fi to a coffee shop Wi-Fi network or transitioning into a notice period after tendering a resignation.

By considering contextual information, identity platform 302 according to embodiments of the present invention may allow for extremely granular policy without cumbersome overhead. This may simplify policy authoring, troubleshooting, and auditing. It also allows policy to adapt to the world around it, rather than traditional systems which force the world around them to conform to supported policy. In general, several contextual factors play a role in Identity and Access Management (IAM). Factors like location, network, device, device posture, and time of week or day may all play a factor in policy authoring. Platform 302 adds additional contextual granularity to this with integration into software version control systems like GitHub, HR systems, file sharing. By analyzing this extensive set of correlated identity and context factors, platform 302 may create an additional contextual factor of baseline, or ‘normal’ behavior. By creating baselines of ‘normal’ behavior, platform 302 may provide additional context for actions policy decisions when actions are outside of that norm.

By correlating identity sources with context, it may be possible to reduce user verification steps. For example, if a trusted device and location is required for a specific action, all information is available to make that decision without having to prompt the user for additional input. This provides a benefit of a reduction in user friction by combining the information sources and context according to the present disclosure. User experience is a critical component of identity and security. Poor user experience, lengthy delays, and the like reduce productivity while also increasing the likelihood of a user attempting to circumvent the given control. Both user experience and security are enhanced through correlated and contextual identity information according to embodiments of the present disclosure.

### Enforcement

Platform 302 may have optional enforcement capability to provide additional security controls that are integrated directly into the adaptive access system 300 according to embodiments of the present disclosure. In situations where enforcement is not otherwise available, not close enough to the resource, or not granular enough, enforcement controls in platform 302 may be used. For environments where this is not desirable platform 302 may provide correlated contextualized identity, granular policy, visibility for use alongside any chosen enforcement tool(s).

Across adaptive access system 300 and platform 302, enforcement may be managed through any combination of a secure browser according to embodiments of the present disclosure, agent 316 according to embodiments of the present disclosure, or customer chosen enforcement tools. Using a secure browser enables enforcement or preventing access at only a user or device level. Secure browser and agent 316 may only expose resources authorized by a policy for a given identity and action, i.e., may enforce or prevent or allow access only at the user or device level. Depending on the resource type, agent 316 may also be capable of utilizing flow control at the application level for enforcement (i.e., process level). In an example embodiment of the present disclosure, a policy may limit file access or downloads for an employee who is transitioning out of the company. Agent 316 and secure browser may also act as one end of an encrypted QUIC tunnel. This tunnel may be used as a secure transport for identity exchange. In another example according to the present disclosure, a user may download an application on their smart phone or device that functions as a secure browser.

In addition, platform 302 may maintain a ledger of identity transactions. This ledger utilizes a transactional Write Once Read Many (WORM) approach to ensure integrity over time. The ledger, in turn, provides an identity-based access audit trail. This ledger ensures auditability of authentication and authorization transactions while providing a powerful forensics tool.

Platform 302 may allow for end-to-end view of a process to a service, i.e., visibility. For each connection, platform 302 may use one or more of the following: source process (including certificates, hash, signature, lineage where available, and/or any other suitable available field), DNS hostnames of requested services, encryption characteristics (e.g., TLS version, SSL library in use, root CA of the service, presented server name attribute), IDs for services (e.g., OneDrive, Dropbox). In one example, encryption characteristics data may be captured a Peek and Splice model such as the one available online at https://wiki.squid-cache.org/Features/SslPeekAndSplice Service ID may allow for linking of the machine ID of the cloud service to the actual machine, such as based on the provider ID. In an example of OneDrive, the registry key of OneDrive stores a machine id on Windows.

In addition, for each system, platform 302 may use one or more of the following: hardware information (CPU ID, other unique identifiable information, including other hardware information), TPM, MDM identity (to correlate to an MDM platform, such as through a JAMF agent data.), network characteristics (WiFi networks, Bluetooth environment, BSSID, MAC, or other suitable network characteristics). In an example embodiment where the network is Wi-Fi the available network characteristics include, but are not limited to, SSID, BSSID (if location is enabled), wlanChannel (Operating frequency of WiFi), rssiValue, noiseMeasurement (noise measurement (dBm) for the Wi-Fi device), countryCode (advertised country code (ISO/IEC 3166-1:1997) for the Wi-Fi device), beaconInterval (beacon interval (ms) for the Wi-Fi device), indication of whether or not the Wi-Fi device is participating in an independent basic service set (IBSS), or ad-hoc Wi-Fi network, indication of whether or not the network supports security, or any combination thereof. In an example of a Bluetooth environment that may be for use with a companion device, characteristics may also include an indication of virtualization (i.e., detecting through any suitable mechanism for macOS or other OS whether the software is being run inside a virtual machine).

File movement may become intensive in terms of computational power or memory requirements. Platform 302 may include a filtering capability where only files getting off a system or going to a cloud platform may be processed or moved. Platform 302 may also support a browser extension or a local socket which may enable communication from the browser extension to the main application. For file movement, platform 302 may receive information about the source/destination path if the path is managed by a daemon (e.g., OneDrive, Dropbox, or other suitable mechanism) or by checking if the path is accessed by a daemon after the file is put there, hash, whether the transfer is occurring locally or externally (e.g., USB, Air Drop, file share).

### Use Cases

Embodiments of agent 316 and platform 302 according to the present invention may be used in a variety of use cases. For example, a Chief Information Security Office (CISO) may be tasked with securing an organization or company. Relevant information to the CISO may include what resources of the organization are located on-premises, on the cloud, and on software services; identities of the collaborators (employees, contractors, partners, etc.) doing business with the organization; how collaborates access the different resources; whether collaborators access resources they should not be accessing; status or progress of “zero trust” journey for organization.

Another use case is for a “Security Architect” tasked with developing and implementing a plan to control access to business resources. Relevant information to the Security Architect include identifying the points in the network where authentication currently occurs; how identities are granted to collaborators (employees, contractors, and partners); assessment of the quality of identity being granted to collaborators; how identities are being checked when collaborators access resources; how to create stronger identities at the source; where stronger identity controls around be inserted around existing applications; suggestions for resource access policies; effectiveness of current resource access policies; current status of resource access policies; need to update resource access policies; and assessment of why resource access policies are working or failing.

In an additional use case, a person charged with security operations may be tasked with monitoring access to business resources. Relevant information to the security operations may be whether there are resources that the organization has lost visibility in to or new resources that should have monitoring added to; whether there are authentication points that are failing; whether there are policy decisions that are causing traffic to be denied; and the trend observed for policy decisions.

There is an additional use case for an Application Owner who is tasked with delivering a secure application with maximum uptime and minimum disruption. Relevant information to the Application Owner may include whether the application is using the best identity markers available; the resource access policy for the application; identities of the collaborators accessing the application; and whether there are collaborators failing to access the application.

As another example, an Identity and Access Management (“TAM”) Manager may be tasked with building a comprehensive understanding of multiple IAM, operational, and security technologies to design and to deploy an architecture streamlining access management activities, ensuring resources are secured, and adapting to changing threat landscapes. Relevant information to the IAM Manager may include identity stores and how they are used; IAM workflows; whether access can be traced back to a single identity; how identity stores compare and resolve each other.

### Example Scenario

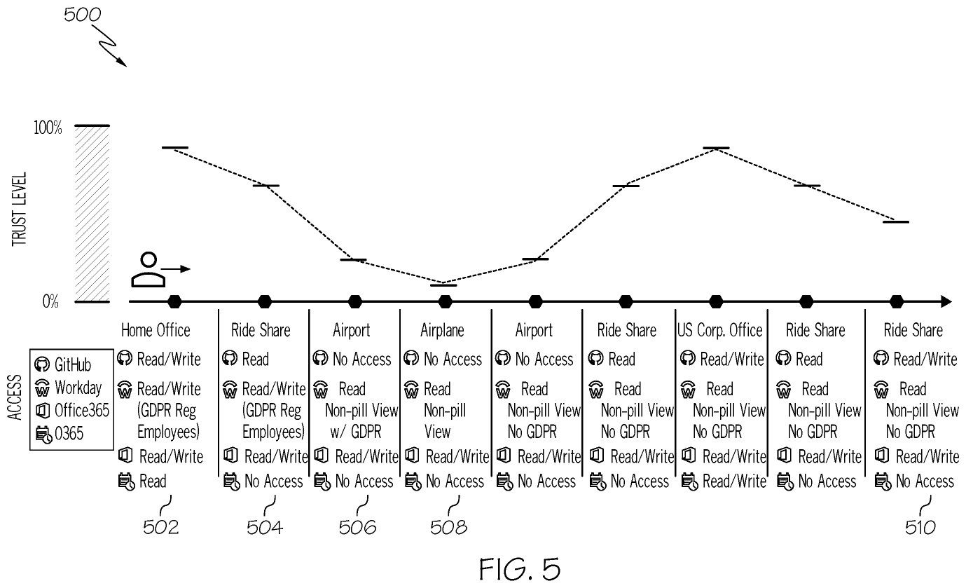

According to an example embodiment 500 depicted in FIG. 5, there is an engineering executive for a data analytics company based in the EU. The engineering executive manages an engineering team building a product. The engineering executive is scheduled for a red-eye flight to the United States (US) to meet with the team in New York.

In a first stage 502, the engineering executive is working from the office in the EU before leaving for the airport and the engineering executive's identity is verified along with the executive's device, and device posture. The engineering executive is authenticated, and contextual information is gathered showing that the executive's device has an approved security posture, the network is a corporate network, and the executive is not outside normal behavior for the executive's identity profile. Based on this information, the engineering executive is authorized to access email, collaboration tools, engineering servers, human resources records for the executive's team, and confidential proprietary information about the product being built.

In a second stage 504, the engineering executive leaves for the airport in a hired car. While in the car, the engineering executive uses a corporate issued phone and a cellular network to catch up on email. An email describing a problem with the code running on an engineering server contains a link to the device. The engineering executive clicks on the link, but platform 302/agent 316 denies the access due to a policy restricting access from mobile devices. The basis of this policy is the ease of loss/theft of mobile devices. Platform 302 notifies the engineering executive of the policy dictating the deny and provides an appeal option.

In a third stage 506, the engineering executive arrives at the airport, and after checking in, the engineering executive locates the airline lounge and connects a laptop to the lounge's Wi-Fi network. The engineering executive is behind on completing employee reviews, so the engineering executive attempts to log into the HR system. Platform 302/agent 316 denies access to the HR system due to a policy based on being connected to public Wi-Fi. The intent of the policy is to protect data on unsecure networks, and to protect data from physical onlookers in shared locations. Again, the engineering executive is notified and provided an option for appeal. The engineering executive instead checks back on the engineering server that was experiencing issues and is now authorized based on using the laptop, which is a trusted device.

In a fourth stage 508, after boarding the plane and taking the assigned seat, the engineering executive begins using the laptop. The engineering executive sees an email about a Product Requirements Document (PRD) review requiring the engineering executive's final approval. The engineering executive clicks the link and is denied access. Policy dictates that confidential, or proprietary information be restricted while in-flight due to the tight quarters and risk of wandering eyes. The engineering executive is provided notification and an appeal option. The engineering executive remembers that this policy will also restrict her access to HR and Engineering servers.

In a fifth stage 510, after the flight lands in New York, the engineering executive arrives at a hotel and again attempts to open the HR system but is denied. The policy dictates that HR records contain PII governed by GDPR regulations. To prevent potential violations, they are restricted from access outside of the EU. Instead, the engineering executive tries to review the PRD that was restricted in-flight. This access is authorized by policy because hotel room Wi-Fi is considered safe from prying eyes.

In this example embodiment 500 depicted in FIG. 5, there is a variable trust level based on the combination of user, device, and process tied to the context of the access request. When using platform 302, trust automatically adjusts to the situation as the factors that affect policy change as illustrated in the example embodiment of FIG. 5.

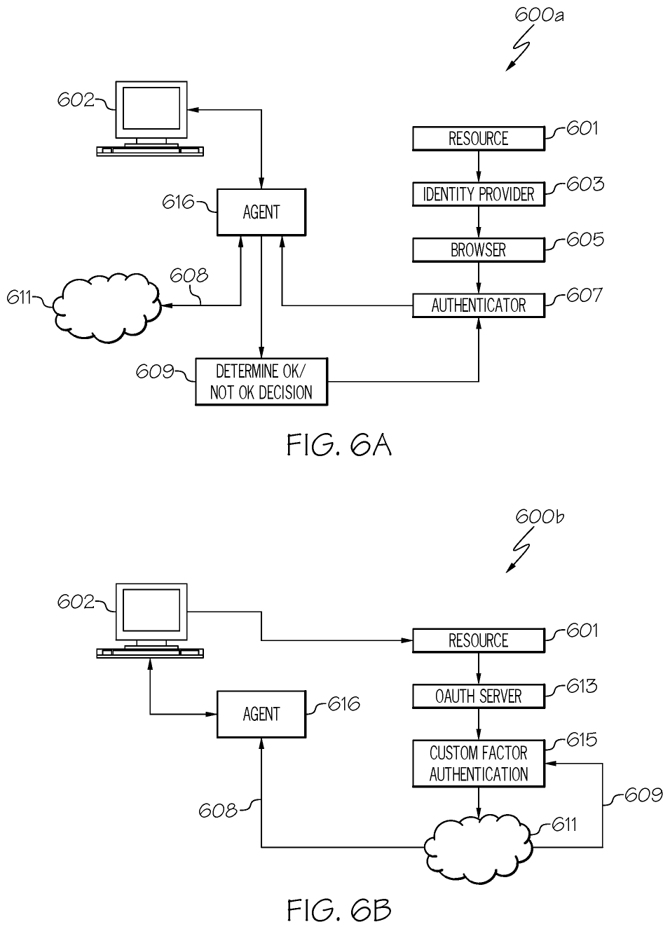

FIGS. 6A & 6B depict example methods of authorizing access according to embodiments of the present invention. In an example embodiment depicted in FIG. 6A, method 600a includes determining whether a user 602 should be given access to a resource 601, via a protocol, such as the FIDO2 protocol. Resource 601, such as cloud-based software or service like SalesForce.com, may communicate with an identity provider 603, such as Okta, to determine whether to grant or deny access user's request to access resource 601. Identity provider 603 may then communicate with a browser 605 including a web-authentication function to determine whether to grant or deny access to the resource 601. Browser 605 may then require authorization or authentication in the form of biometric or other multi-factor authentication (authenticator 607) to determine whether to grant or deny access. Authenticator 607, acting as a virtual human interface device (HID), may communicate with agent 616. Agent 616 may communicate with cloud 611 that may be part of the adaptive access platform to obtain policy information 608. Cloud 611 may determine as described herein whether to grant access, deny access, or take other action based on policy 608 and may communicate the decision 609 to user 602 via agent 616. Agent 616 may also provide a notification of the decision 609 made in cloud 611 to authenticator 607. In this embodiment, decision 609 may be encrypted such that it cannot be modified by agent 616. Agent 616 informs user 602 of decision 609 made in cloud 611 and also may request additional information from user 602 (e.g., click here to approve, instruction to get phone, etc.). Policy 608 may include policies authored by the user, user's company, or other suitable entity in accordance with policy engine 308, as described herein.

In another example embodiment depicted in FIG. 6B, method 600b includes determining whether a user 602 should be given access to a resource 601 via custom factor authentication. Resource 601, such as cloud-based software or service like SalesForce.com, may then communicate with an OAuth server 613 to determine whether to grant or deny access to resource 601 y user 602. OAuth server 613 may then communicate with custom factor authentication 615. Custom factor authentication 615 may occur via IDP extensions and may be any suitable custom factors or controls such as Okta custom factors or Microsoft Custom Controls. Custom factor authentication 615 may communicate with cloud 611, which may communicate regarding policy 608 with agent 616. Agent 616 may communicate with cloud 611 that may be part of the adaptive access platform to obtain policy information 608. Cloud 611 may determine as described herein whether to grant access, deny access, or take other action based on policy 608 and may communicate the decision 609 to user 602 as defined in the policy 608. Agent 616 may also provide a notification of the decision 609 to custom factor authentication 615 via cloud 611. Agent 616 also may request additional information from user 602 (e.g., click here to approve, instruction to get phone, etc.). Policy 608 may include policies authored by the user, user's company, or other suitable entity in accordance with policy engine 308, as described herein.

It should be understood that the terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method for authentication, authorization, and access-control, the method comprising:
receiving identity information from one or more sources regarding a user attempting to access a resource;
consolidating the received identity information into a contextualized identity for the user;
determining whether to authenticate the user based on the contextualized identity;
receiving at least one piece of contextual information related to the user; and
determining whether to enforce a policy based on the authentication of the contextualized identity and at least one piece of contextual information.

2. The method of claim 1, wherein determining to enforce the policy based on the authentication of the contextualized identity and at least one piece of contextual information comprises one or more of granting access to the resource, denying access to the resource, or throttling access to the resource.

3. The method of claim 2, further comprising notifying the user of the determination to grant access to the resource, deny access to the resource, or throttle access to the resource.

4. The method of claim 1, wherein the at least one piece of contextual information comprises location, network security, human resource status, attached network, or geo-location related compliance regulations.

5. The method of claim 1, wherein the contextualized identity comprises a trust level associated with the user.

6. The method of claim 5, further comprising automatically adjusting the trust level based on the at least one piece of contextual information related to the user.

7. A computer configured to access a storage device, the computer comprising:
a processor; and
a non-transitory, computer-readable storage medium storing computer-readable instructions that when executed by the processor cause the computer to perform:
receiving identity information from one or more sources regarding a user attempting to access a resource;
consolidating the received identity information into a contextualized identity for the user;
determining whether to authenticate the user based on the contextualized identity;
receiving at least one piece of contextual information related to the user; and
determining whether to enforce a policy based on the authentication of the contextualized identity and at least one piece of contextual information.

8. The method of claim 7, wherein determining to enforce the policy based on the authentication of the contextualized identity and at least one piece of contextual information comprises one or more of granting access to the resource, denying access to the resource, or throttling access to the resource.

9. The method of claim 8, further comprising notifying the user of the determination to grant access to the resource, deny access to the resource, or throttle access to the resource.

10. The method of claim 7, wherein the at least one piece of contextual information comprises location, network security, human resource status, attached network, or geo-location related compliance regulations.

11. The method of claim 7, wherein the contextualized identity comprises a trust level associated with the user.

12. The method of claim 11, further comprising automatically adjusting the trust level based on the at least one piece of contextual information related to the user.

13. A computer program product comprising:
a computer-readable storage medium having computer-readable program code embodied therewith, the computer-readable code comprising computer-readable program code configured to:
receive identity information from one or more sources regarding a user attempting to access a resource;
consolidate the received identity information into a contextualized identity for the user;
determine whether to authenticate the user based on the contextualized identity;
receive at least one piece of contextual information related to the user; and
determine whether to enforce a policy based on the authentication of the contextualized identity and at least one piece of contextual information.

14. The method of claim 13, wherein determining to enforce the policy based on the authentication of the contextualized identity and at least one piece of contextual information comprises one or more of granting access to the resource, denying access to the resource, or throttling access to the resource.

15. The method of claim 14, further comprising notifying the user of the determination to grant access to the resource, deny access to the resource, or throttle access to the resource.

16. The method of claim 13, wherein the at least one piece of contextual information comprises location, network security, human resource status, attached network, or geo-location related compliance regulations.

17. The method of claim 13, wherein the contextualized identity comprises a trust level associated with the user.

18. The method of claim 17, further comprising automatically adjusting the trust level based on the at least one piece of contextual information related to the user.
